(19) United States
(12) Patent Application Publication
(10) Pub. No.: US 2026/0005356 A1
(43) Pub. Date: Jan. 1, 2026

(54) METHOD OF MANUFACTURING JOINED BODY, JOINED BODY, AND ALUMINUM HOLLOW MEMBER FOR BATTERY CASE

(71) Applicant: TOYOTA JIDOSHA KABUSHIKI KAISHA, Toyota-shi (JP)

(72) Inventor: Osamu YAMASHITA, Toyota-shi (JP)

(73) Assignee: TOYOTA JIDOSHA KABUSHIKI KAISHA, Toyota-shi (JP)

(21) Appl. No.: 19/043,789

(22) Filed: Feb. 3, 2025

(30) Foreign Application Priority Data
Jun. 26, 2024 (JP) 2024-102823

(51) Int. Cl. H01M 50/224; B23K 20/12; B23K 101/36; B23K 103/10

(52) U.S. Cl. CPC H01M 50/224; B23K 20/1225; B23K 2101/36; B23K 2103/10

(57) ABSTRACT

A method of manufacturing a joined body includes a disposition step and a joining step. In the disposition step, the members to be joined are arranged to be in contact with each other. In the joining step, the rotating tool is pressed and is caused to proceed in the joining direction to join the members to be joined by friction stir. A protruding portion is formed on at least one of the members to be joined in parallel to a joining direction. The members to be joined in which the protruding portions are formed are disposed to be pressed by the friction stir welding tool. The protruding portion is disposed to be in contact with a side where the joining direction and the rotation direction of the tool coincide with each other.

### CROSS-REFERENCE TO RELATED APPLICATION

This application claims priority to Japanese Patent Application No. 2024-102823 filed on Jun. 26, 2024. The disclosure of the above-identified application, including the specification, drawings, and claims, is incorporated by reference herein in its entirety.

### BACKGROUND

### 1. Technical Field

The present disclosure relates to a method of manufacturing a joined body, a joined body, and an aluminum hollow member for a battery case.

### 2. Description of Related Art

Friction stir welding is a technology for joining members to be joined using a cylindrical tool having a protrusion at a tip. Specifically, a friction stir welding device presses the members to be joined while the friction stir welding device rotates the tool. The tool softens the members to be joined with frictional heat and kneads the vicinity of a joint portion to join the members to each other. Friction stir welding has been attracting attention in recent years as an energy-saving joining method that does not require the preparation of a special environment or pretreatment of a member to be joined.

Friction stir welding is generally performed using a processing machine having high rigidity, but the processing machine is expensive. By implementing friction stir welding using a less expensive robot, a cost reduction can be achieved. On the other hand, in the friction stir welding using a robot, a trajectory of a joint is likely to deviate from a target due to insufficient rigidity, resulting in a reduction in joint strength.

Japanese Unexamined Patent Application Publication No. 2023-020192 (JP 2023-020192 A) discloses a friction stir welding device including a rotation vibration suppression mechanism. The rotation vibration suppression mechanism suppresses meandering due to rotation wobble by continuously limiting a lateral movement range by clamping a spindle housing without hindering the advancement of a joint tool through an advancement auxiliary member.

### SUMMARY

The friction stir welding device disclosed in JP 2023-020192 A suppresses meandering of the joining tool by clamping the spindle housing using the rotation vibration suppression mechanism and continuously limiting a lateral movement range. However, a guide member, which is the rotation vibration suppression mechanism, may deviate from a predetermined position during installation. As a result, there is a problem in that a planned joint point and an actual joint point may deviate.

Considering the above problems, an object of the present disclosure is to provide a method of manufacturing a joined body in which friction stir welding is performed without deviation of a joint trajectory from a target.

An aspect of the disclosure relates to a method of manufacturing a joined body including a disposing step and a joining step.

In the disposing step, a plurality of members to be joined is disposed such that the members to be joined are arranged to be in contact with each other.

In the joining step, the members to be joined are joined through friction stir welding by pressing a friction stir welding tool that rotates and causing the friction stir welding tool to proceed in a joining direction.

At least one of the members to be joined includes a protruding portion provided in parallel to the joining direction.

The member to be joined in which the protruding portion is provided is disposed to be pressed by the friction stir welding tool.

The protruding portion is disposed to be in contact with a side of the friction stir welding tool on which the joining direction and a rotation direction of the friction stir welding tool coincide with each other.

In the method, in the disposing step, two of the members to be joined may be arranged in parallel such that the two members to be joined are in contact with each other to form one surface, and the one surface may have a tangent line where the two members to be joined are in contact with each other.

In this case, the protruding portion may be disposed on one of the two members to be joined, the one of the two members to be joined being on a side on which the joining direction and the rotation direction coincide with each other with respect to the tangent line, and the protruding portion may be provided at a distance from the tangent line based on a radius of the friction stir welding tool.

The method may further include a cutting step of cutting a joint trace after the joining step.

In this case, the protruding portion may be removed in the cutting step.

An aspect of the disclosure relates to a joined body including a plurality of members to be joined, the members to be joined are joined by friction stir welding. One surface of the joined body may have a joint line formed by the friction stir welding and a cut trace including the joint line as a region.

The cut trace may have, across the joint line, a coincidence side on which a joining direction and a rotation direction in the friction stir welding coincide with each other and an opposite side on which the joining direction and the rotation direction in the friction stir welding are opposite to each other.

A width of the cut trace on the coincidence side may be larger than a width of the cut trace on the opposite side with respect to the joint line.

An aspect of the disclosure relates to an aluminum hollow member for a battery case including a first surface, a second surface, a third surface, a fourth surface, a fifth surface, and a sixth surface.

The second surface is opposite to the first surface. The third surface is connected to the first surface and the second surface. The fourth surface is connected to the first surface and the second surface and is opposite to the third surface. The fifth surface is connected to the first surface, the second surface, the third surface, and the fourth surface. The sixth surface is connected to the first surface, the second surface, the third surface, and the fourth surface, and is opposite to the fifth surface.

In the aluminum hollow member for a battery case, the first surface may have a protruding portion provided in parallel to an edge connected to the third surface at a predetermined distance from the edge.

According to the present disclosure, it is possible to provide a method of manufacturing a joined body in which friction stir welding is performed without deviation of a joint trajectory from a target, a joined body, and an aluminum hollow member for a battery case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a manufacturing step of a joined body according to Embodiment 1;

FIG. 2 is a cross-sectional view of a manufacturing step of a joined body according to Embodiment 1;

FIG. 3 is a perspective view of a joined body according to Embodiment 2; and

FIG. 4 is a perspective view of an aluminum hollow member for a battery case according to Embodiment 3.

### DETAILED DESCRIPTION OF EMBODIMENTS

Hereinafter, the present disclosure will be described through embodiments, but the disclosure according to the claims is not limited to the following embodiments. Moreover, not all of the configurations described in the embodiments are indispensable as means for solving the problem. For clarification of the description, the following description and drawings are appropriately omitted and simplified. In each drawing, the same reference numerals are given to the same elements, and redundant description is omitted as needed.

### Embodiment 1

In Embodiment 1, the method of manufacturing a joined body includes a disposition step and a joining step. In the disposition step, the members to be joined are arranged to be in contact with each other. Here, a protruding portion is formed on at least one of the members to be joined in parallel with the joining direction. The member to be joined in which the protruding portions are formed is disposed such that the tool for friction stir welding is pressed thereagainst. In addition, the protruding portion is disposed to be in contact with a side on which the joining direction and the rotation direction of the friction stir welding tool coincide with each other. In the joining step, the rotating friction stir welding tool is pressed and is caused to proceed in the joining direction to join the coincidence side member and the opposite side member, which are the members to be joined adjacent to each other, by friction stir.

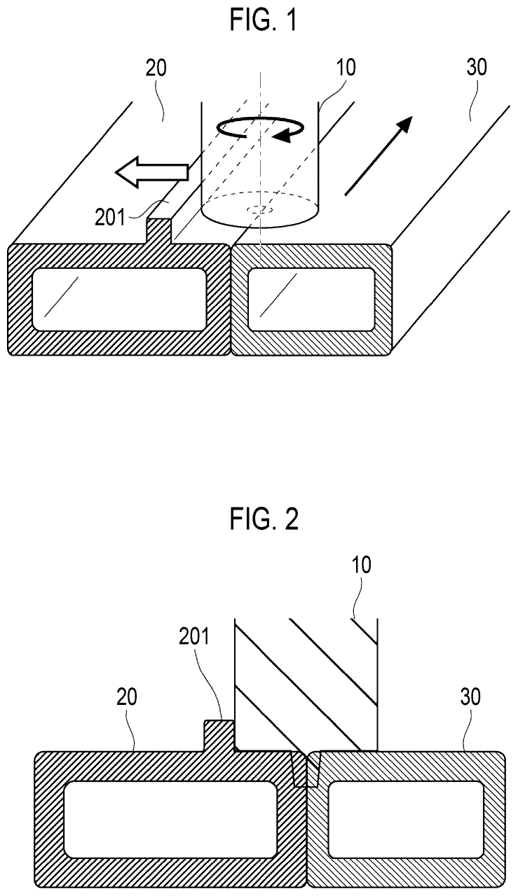

Next, a method of manufacturing a joined body in the present disclosure will be described with reference to FIG. 1. FIG. 1 is a perspective view of a manufacturing step of a joined body according to Embodiment 1. Here, the friction stir welding is used for manufacturing the joined body. The friction stir welding is also called friction stir welding (FSW). In FIG. 1, in the manufacturing of the joined body, a friction stir welding tool 10, a coincidence side member 20, and an opposite side member 30 are used. Specifically, a joining device (not shown) presses the rotating friction stir welding tool 10 to proceed in the joining direction, and joins the coincidence side member 20 and the opposite side member 30, which are members to be joined, by friction stir. Here, the joining device has, for example, a multi-joint robot arm, and can move the tool 10 along a predetermined trace. The coincidence side member 20 and the opposite side member 30 are each an aluminum hollow 15 member.

The tool 10 is used to join the coincidence side member 20 and the opposite side member 30. In FIG. 1, the tool 10 moves while rotating in the right direction on the surface on which the coincidence side member 20 and the opposite side member 30 come into contact with each other, with the backward direction as the joining direction. The tool 10 moves in a joining direction indicated by a solid line arrow shown in FIG. 1. As a result, the tool 10 joins the coincidence side member 20 and the opposite side member 30. Here, a side where the joining direction and the rotation direction of the tool 10 coincide with each other is referred to as a coincidence side or an advancing side (AS). In addition, a side on which the joining direction and the rotation direction are opposite to each other is referred to as an opposite side or a retreating side (RS). Therefore, in FIG. 1, the coincidence side of the tool 10 is the left side with respect to the joining direction. In addition, in FIG. 1, the opposite side is the right side with respect to the joining direction of the tool 10.

The tool 10 receives a force in the direction of the white arrow in FIG. 1, that is, the direction of the coincidence side of the member to be joined due to friction with the member to be joined in friction stir welding. Therefore, in the manufacturing method using the general friction stir welding, in a case where the rigidity of the device or the robot that supports the tool 10 is not sufficient for the force in the coincidence side direction, the joint trace is curved toward the coincidence side.

Next, the coincidence side member 20 is a member to be joined disposed on the coincidence side with respect to the tool 10. The coincidence side member 20 has a protruding portion 201 such that the tool 10 comes into contact with the upper surface. In addition, the opposite side member 30 is a member to be joined disposed on the opposite side of the tool 10. The coincidence side member 20 and the opposite side member 30 are arrange in parallel to form one surface in contact with each other.

One surface formed by the coincidence side member 20 and the opposite side member 30 has a tangent line at which the coincidence side member 20 and the opposite side member 30 are in contact with each other. In the top view, the tangent line is a straight line indicating the boundary between the coincidence side member 20 and the opposite side member 30. By arranging the coincidence side member 20 and the opposite side member 30, the coincidence side member 20 and the opposite side member 30 form a tangent line on one surface. The tool 10 moves along the tangent line and joins the coincidence side member 20 and the opposite side member 30. The coincidence side member 20 and the opposite side member 30 are, for example, aluminum materials. The coincidence side member 20 and the opposite side member 30 may be made of copper material or steel material. In addition, the coincidence side member 20 and the opposite side member 30 may be members made of different materials. The coincidence side member 20 and the opposite side member 30 may not be hollow members.

The protruding portion 201 is disposed on the coincidence side member 20. In addition, the protruding portion 201 is formed to be parallel to the tangent line on one surface and to be separated by a distance based on the radius of the friction stir welding tool 10 from the tangent line. As a result, the protruding portion 201 is in contact with the friction stir welding tool 10, and the tool 10 can be prevented from intruding into the coincidence side. The protruding portion 201 is continuously formed in a direction parallel to the tangent line. That is, in the tangential direction, the protruding portion 201 is continuously formed from one end to the second end of the coincidence side member 20.

Here, with reference to FIG. 2, the protruding portion 201 of the coincidence side member 20 is disposed to be in contact with the side where the joining direction and the rotation direction of the tool 10 coincide. FIG. 2 is a cross-sectional view of a manufacturing step of a joined body according to Embodiment 1. In FIG. 2, the tool 10 is assumed to be joined in a direction toward the back and to be rotated clockwise. The provided protruding portion 201 serves as a wall that prevents the tool 10 from entering the coincidence side, and can prevent the joint trajectory from deviating from the target. Therefore, it is possible to provide a method of manufacturing a joined body that is friction stir welded without causing a joint trajectory to deviate from an aim. A portion of the tip of the tool 10 that is thinned is referred to as a probe.

The height of the protruding portion 201 is not particularly limited, but when the height is too low, it is difficult to prevent the friction stir welding tool 10 from entering the coincidence side. The height of the protruding portion 201 needed to sufficiently prevent the friction stir welding tool 10 from entering the friction stir welding tool 10 on the coincidence side is affected by the radius of the friction stir welding tool 10, the radius of the probe, the joining speed, and the like. The height of the protruding portion 201 may be, for example, 3 mm or more. In addition, the height of the protruding portion 201 may be, for example, equal to or greater than the radius of the probe. The protruding portion 201 may be formed at a constant height or may have a partially different height.

When the angle of the side surface of the protruding portion 201 with respect to the surface of the coincidence side member 20 is too small, the tool 10 goes up the side surface of the protruding portion 201, and it is difficult to prevent the tool 10 from entering the coincidence side. Therefore, the angle of the side surface of the protruding portion 201 is desirably close to 90 degrees with respect to the surface of the coincidence side member 20. In addition, an angle of the side surface of the protruding portion 201 may exceed 90 degrees with respect to the surface of the coincidence side member 20.

In the above, in Embodiment 1, the method of manufacturing a joined body using the friction stir welding in the abutment joint in which the members are arranged in parallel has been described. On the other hand, the method of manufacturing a joined body according to the present disclosure can also be applied to lamination joining in which members are laminated and joined to each other. In this case, in the method of manufacturing a joined body according to the present disclosure, the protruding portion is formed in the member to be joined disposed at the top, whereby it is possible to prevent the joint trajectory from being deviated from the target.

Further, for the description, a case where two members are joined has been described, but the method of manufacturing a joined body according to the present disclosure may join three or more members in a row. In this case, the opposite side member 30 has the protruding portion 201 in the same manner as the coincidence side member 20, and the member to be joined is further disposed to be adjacent to the opposite side of the coincidence side member 20 with respect to the opposite side member 30. According to the aspect, the method of manufacturing a joined body according to the present disclosure can join a plurality of members to be joined in series.

### Embodiment 2

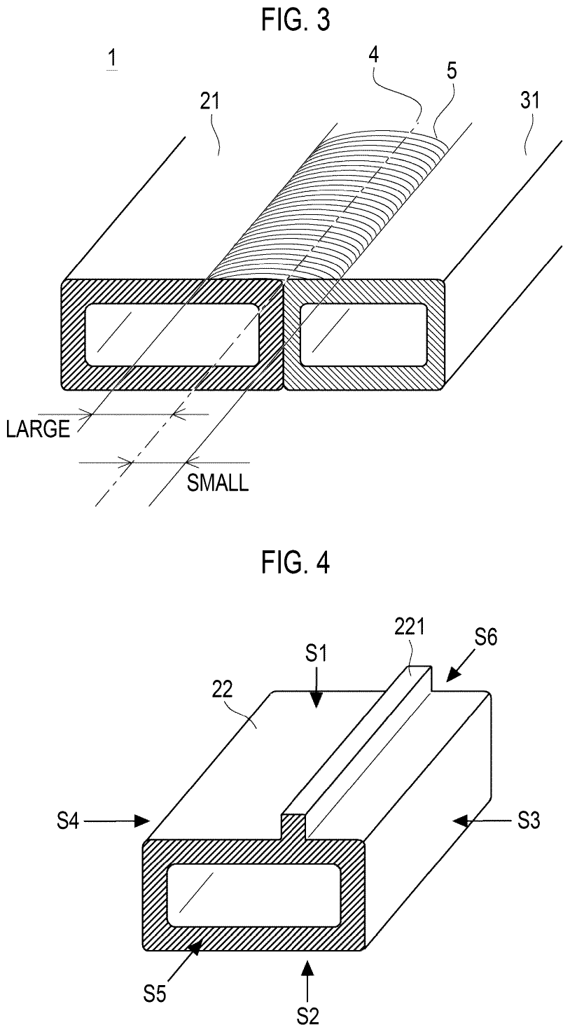

Next, Embodiment 2 in the present disclosure will be described with reference to FIG. 3. FIG. 3 is a perspective view of a joined body 1 according to Embodiment 2. The joined body 1 is a joined body that is manufactured by the manufacturing method described in Embodiment 1 and then subjected to a cutting step.

The cutting step is a step of cutting the joint trace after the joining step. In addition, the cutting step removes the protruding portion 201. In the cutting step, the removal of the protruding portion 201 may be performed in the same work as the cutting of the joint trace. Accordingly, with the method of manufacturing a joined body according to the present disclosure, a new step is not added by forming the protruding portion 201, and the joined body can be efficiently manufactured.

The joined body 1 is a joined body including a coincidence side member 21 and an opposite side member 31 joined by friction stir welding. The joined body 1 has a joint line 4 and a cut trace 5 including the joint line 4 by friction stir welding on one surface as a region. The joint line 4 corresponds to the tangent line shown in Embodiment 1.

The coincidence side member 21 is the coincidence side member 20 described in Embodiment 1, which is joined to the opposite side member 30. In addition, the coincidence side member 21 is obtained by cutting the protruding portion 201 from the coincidence side member 20 described in Embodiment 1, and forming a part of the cut trace 5 at the position of the protruding portion 201. The opposite side member 31 is the opposite side member 30 described in Embodiment 1, which is joined to the coincidence side member 20. The joint line 4 is a place where the coincidence side member 21 and the opposite side member 31, which can be confirmed on the surface of the joined body 1, are joined by friction stir welding.

The cut trace 5 includes a coincidence side in which a joining direction and a rotation direction in the friction stir welding coincide with each other and an opposite side in which the joining direction and the rotation direction in the friction stir welding are opposite to each other, with the joint line 4 interposed therebetween. The cut trace 5 is a trace of cutting the joint trace and the protruding portion 201 in the joined body manufactured by the manufacturing method according to Embodiment 1. The joint trace and the protruding portion 201 may be cut in the same step. According to the above, the joined body according to the present disclosure is manufactured by friction stir welding without increasing the number of work steps and without causing the joint trajectory to deviate from the target by using the protruding portion 201.

Due to cutting of the protruding portion 201, in the cut trace 5, a width of the coincidence side and a width of the opposite side are asymmetric with respect to the joint line 4. More specifically, the width of the cut trace 5 on the coincidence side is wider than the width of the cut trace 5 on the opposite side. The minimum width of the cut trace 5 on the opposite side is the radius of the tool 10 with the joint line 4 as a reference. In addition, the minimum width of the cut trace 5 on the coincidence side is a length obtained by adding the width of the protruding portion 201 to the radius of the tool 10 with the joint line 4 as a reference.

As a result, the joined body according to the present disclosure can provide the joined body obtained by friction stir welding without deviation of the joint trajectory from the target.

### Embodiment 3

Embodiment 3 in the present disclosure will be described with reference to FIG. 4. FIG. 4 is a perspective view of an aluminum hollow member 22 for a battery case according to Embodiment 3. The aluminum hollow member 22 is used for manufacturing a bottom surface of a battery case or the like by arranging a plurality of the aluminum hollow members 22 in parallel and friction stir welding the aluminum hollow members 22 to each other. Here, the battery case is, for example, a case for housing a battery of a battery electric vehicle. Specifically, the aluminum hollow member 22 is the coincidence side member 20 in Embodiment 1.

The aluminum hollow member 22 has a first surface S1, a second surface S2, a third surface S3, a fourth surface S4, a fifth surface S5, and a sixth surface S6. The second surface S2 is opposite to the first surface S1. The third surface S3 is connected to the first surface S1 and the second surface S2. A fourth surface S4 is connected to the first surface S1 and the second surface S2 and is opposite to the third surface S3. The fifth surface S5 is connected to the first surface S1, the second surface S2, the third surface S3, and the fourth surface S4. The sixth surface S6 is connected to the first surface S1, the second surface S2, the third surface S3, and the fourth surface S4, and is opposite to the fifth surface S5. The aluminum hollow member 22 is provided with a protruding portion 221 formed in parallel with the edge at a predetermined distance from the edge connected to the third surface S3 on the first surface S1.

The first surface S1 is one surface of the joined body 1 shown in Embodiments 1 and 2. By disposing the aluminum hollow members 22 such that the first surface S1 is the upper surface and the third surface S3 and the fourth surface S4 are adjacent to each other and friction stir welding the aluminum hollow members 22, the method of manufacturing a joined body of the present disclosure can form each surface of the battery case by using the aluminum hollow members 22. As a result, the aluminum hollow member for a battery case according to the present disclosure can provide a joined body obtained by friction stir welding without causing a deviation of the joint trajectory from the target. Therefore, by using the aluminum hollow member 22, the productivity of the battery case can be improved. In the friction stir welding step, two or more of the aluminum hollow members 22 shown in FIG. 4 may be arranged, or the aluminum hollow members 22 shown in FIG. 4 and the opposite side member 30 shown in FIG. 1 may be arranged.

Although the present disclosure has been described with reference to the embodiments, the present disclosure is not limited to the above embodiments, and can be appropriately modified without departing from the spirit of the present disclosure. For example, a plurality of plate-shaped members is laminated, and a protruding portion is formed in a linear shape on a member located at an uppermost portion, whereby the members can be friction stir welded without deviation of a joint trajectory from an intended position.

What is claimed is:

1. A method of manufacturing a joined body, the method comprising:
a disposing step of disposing a plurality of members to be joined such that the members to be joined are arranged to be in contact with each other; and
a joining step of joining the members to be joined through friction stir welding by pressing a friction stir welding tool that rotates and causing the friction stir welding tool to proceed in a joining direction, wherein:
at least one of the members to be joined includes a protruding portion provided in parallel to the joining direction;
the member to be joined in which the protruding portion is provided is disposed to be pressed by the friction stir welding tool; and
the protruding portion is disposed to be in contact with a side of the friction stir welding tool on which the joining direction and a rotation direction of the friction stir welding tool coincide with each other.

2. The method according to claim 1, wherein:
in the disposing step, two of the members to be joined are arranged in parallel such that the two members to be joined are in contact with each other to form one surface;
the one surface has a tangent line where the two members to be joined are in contact with each other;
the protruding portion is disposed on one of the two members to be joined, the one of the two members to be joined being on a side on which the joining direction and the rotation direction coincide with each other with respect to the tangent line; and
the protruding portion is provided at a distance from the tangent line based on a radius of the friction stir welding tool.

3. The method according to claim 2, further comprising a cutting step of cutting a joint trace after the joining step, wherein the protruding portion is removed in the cutting step.

4. A joined body comprising a plurality of members to be joined, the members to be joined being joined by friction stir welding, wherein:
one surface of the joined body has a joint line provided by the friction stir welding and a cut trace including the joint line as a region;
the cut trace has, across the joint line, a coincidence side on which a joining direction and a rotation direction in the friction stir welding coincide with each other and an opposite side on which the joining direction and the rotation direction in the friction stir welding are opposite to each other; and
a width of the cut trace on the coincidence side is larger than a width of the cut trace on the opposite side with respect to the joint line.

5. An aluminum hollow member for a battery case, the aluminum hollow member comprising:
a first surface;
a second surface opposite to the first surface;
a third surface connected to the first surface and the second surface;
a fourth surface connected to the first surface and the second surface and opposite to the third surface;
a fifth surface connected to the first surface, the second surface, the third surface, and the fourth surface; and
a sixth surface connected to the first surface, the second surface, the third surface, and the fourth surface and opposite to the fifth surface,
wherein the first surface includes a protruding portion provided in parallel to an edge connected to the third surface at a predetermined distance from the edge.
